(19) United States
(12) Patent Application Publication
(10) Pub. No.: US 2018/0169923 A1
(43) Pub. Date: Jun. 21, 2018

(54) SPACER PRODUCT

(71) Applicant: Velcro BVBA, Deinze (BE)

(72) Inventors: Joshua W. Whitcomb, Raymond, NH (US); Gregory K. Kopanski, Candia, NH (US); Mark A. Clarner, Hopkinton, NH (US); James L. Tardiff, Manchester, NH (US); Mary L. Watts, Warner, NH (US)

(21) Appl. No.: 15/841,592

(22) Filed: Dec. 14, 2017

Related U.S. Application Data
(60) Provisional application No. 62/437,184, filed on Dec. 21, 2016.

(51) Int. Cl. B29C 47/00; B29C 70/08; B29C 70/20; B32B 5/12

(52) U.S. Cl. CPC B29C 47/0021; B29C 70/085; D04H 11/00; B32B 5/12; B29C 70/205

(57) ABSTRACT

A spacer product (e.g., a fabric) has long and thin stems welded to, interconnecting and extending from, two spaced flexible carrier sheets, such as of thin film. A precursor sheet product may be made by orienting thin, hollow, drawn staple fibers between bristles of a brush, and then fusing a film to the fiber ends by direct welding. The fibers are then withdrawn from the brush as stems with distal ends that are secured to another carrier sheet to form the spacer product.

### TECHNICAL FIELD

This invention relates to spacer products, such as spacer fabrics with two flexible sheets of material held in spaced apart relation by interconnecting elements.

### BACKGROUND

Spacer products, such as spacer fabrics, are frequently employed where relatively high thickness to weight ratios are needed, or where it is desired to space two flexible surfaces apart from each other in an efficient manner. They can be found in use as insulating layers in clothing, for example, with air between two spaced-apart fabric layers providing added thermal insulation. Such spacer fabrics tend to be formed by weaving or knitting processes, with two layers of fabric simultaneously formed with yarns interconnecting them. Such processes can be expensive for some applications, and are limited in the resulting structures that can be readily created.

### SUMMARY

According to one aspect of the invention, a spacer product (such as a flexible fabric) has two spaced apart carrier sheets, each carrier sheet having a side surface facing the other carrier sheet, and a multiplicity of non-tapered resin stems extending from and interconnecting the side surfaces of the carrier sheets. The stems extend at different angles from the carrier sheets, rather than being all perfectly perpendicular, and are secured to the side surfaces of the carrier sheets at weld points in which resin of the stems is solidified in a weld with resin of the side surface.

By extending at different angles, we mean that a longitudinal axis of one stem extends at one angle to the base, while the same longitudinal axis of another stem extends at a different angle, etc. In many cases, the stems extend from the base with a pseudo-random arrangement of angles and positions.

In some examples, one or both side surfaces are formed by resin film. The stems and the film of the side surfaces may be of similar thickness, and in some cases the film is substantially thinner than the stems. The resin film forming the side surfaces may also form opposite surfaces of the carrier sheets, with the carrier sheets each essentially consisting of a single film layer.

In some cases, the stems are in the form of cylindrical tubes.

The stems of some such spacer products are hollow, and may have longitudinal seams extending along their length. The hollow stems may define passages through the spacer product, the passages open at outer surfaces of the carrier sheets (such as to allow passage of fluid (gas and/or liquid) through the product along the stems). In some cases, the passages are sealed to a cavity defined between the carrier sheets.

The stems preferably have a length-to-thickness ratio of between 10 and 60, or for some applications between 20 and 50. The stems preferably have a nominal stem length of at least 1.5 mm, and/or a nominal thickness of less than about 0.2 mm. In some cases, the stems are of different nominal thicknesses. The stems may be of longitudinally drawn resin, such as from being formed by spinnerets.

Typically, the stems will be of a pseudo-random distribution across the base, rather than in an exact, repeating pattern. We say ‘pseudo-random’ to clarify that there may be some tendency to having greater stem densities in certain regions simply due to the physical forces involved in distributing the stem fibers during processing, and that exact mathematical randomness is not the objective. The stems need not be each accurately positioned according to a pattern in order to form a useful fastening.

In some embodiments, the fibers are bicomponent fibers, such as fibers having a sheath of one resin overlaying a core of another resin. In such cases, the sheath resin may be welded to resin of one or both of the carrier sheets.

For some applications, one or both of the carrier sheets is or includes a non-woven fabric. In such cases, the stems may be welded directly to resin of fibers of the non-woven fabric, such as by the methods discussed below.

In some examples, at least one of the carrier sheets is air-permeable throughout its thickness.

In some embodiments the spacer product also includes unattached stems disposed between the carrier sheets, each unattached stem secured to only one of the carrier sheets. These unattached stems are in addition to the stems connecting the two carrier sheets. Making a useful spacer product does not require connection at both ends of every stem.

In some cases, at least many of the stems each define a bend spaced from each of the carrier sheets.

For some uses, the side surfaces bound a sealed internal cavity within the spacer product. This can be formed, for example, by sealing the edges of a section of the spacer product while leaving the carrier sheets spaced apart in a central region of the product.

For example, another aspect of the invention features a flexible medical patch formed from the spacer product described herein, with one carrier sheet forming an impermeable outer cover and the other carrier sheet forming a permeable inner liner (such as a perforated film or a non-woven material). The outer cover and inner liner are sealed about edges of the patch, with the stems holding the outer cover spaced from the inner liner in an interior region of the patch. Adhesive may be disposed on the inner liner adjacent the edges of the patch, to secure the patch in use. Medicament may be disposed between the outer cover and the inner liner, between the stems.

Another aspect of the invention features a method of making a spacer product. The method includes orienting a number of extruded resin fibers in a common direction (such as with an end of each fiber exposed and positioned within a distance of a common datum, the distance being less than 20 percent of an average length of the fibers), engaging the exposed ends of the fibers with a side of a first carrier sheet extending normal to the common direction, permanently securing the engaged ends of the fibers to the first carrier sheet by welding resin of the fibers to resin of the first carrier sheet (forming a precursor sheet with the fibers having distal ends spaced from the first carrier sheet), and securing the distal ends of the fibers to a surface of a second carrier sheet, such that the fibers hold the first and second carrier sheets in a spaced relation.

In some cases, the first carrier sheet has a film forming the side of the first carrier sheet (or the first carrier sheet is a film). The engaged ends of the fibers may be secured to the first carrier sheet by forming forms welds extending beyond sides of the fibers, such that the welds have a lateral extent, at the side of the resin film, at least twice a nominal thickness of the secured fibers. In some cases, permanently securing the engaged ends of the fibers to the first carrier sheet forms holes in the film.

In some examples of the method, orienting the number of extruded resin fibers in the common direction involves holding the fibers between and parallel to bristles of a brush, with the exposed ends of the fibers extending to or beyond distal ends of the brush bristles. For example, the datum may be a plane spaced a determined distance from the distal ends of the brush bristles. Orienting the fibers in the common direction may involve needling the fibers into the brush. Before needling the fibers, the fibers may be supported on the distal ends of the brush bristles as an incoherent batt of staple fibers. After needling the fibers, unoriented fibers may be removed from the brush (such as by a vacuum) while holding the oriented fibers between the brush bristles.

In some cases, orienting the number of extruded resin fibers in the common direction involves, while holding the fibers between and parallel to the brush bristles, pressing the exposed ends of the fibers toward the brush to position the exposed ends with respect to the datum.

The brush bristles may have a free length to thickness ratio of between 10 and 100, for example. In this respect, ‘free length’ is the overall length of the bristle from where it is secured in the brush body to its free end. Ideally, the brush bristles are sufficiently densely packed that the oriented fibers are held in their oriented position by adjacent bristles.

The method described above may be performed as a continuous process, the brush being in the form of a recirculating belt that moves sequentially through a fiber laying station, a needling station, a securing station, a product removing station, and a brush cleaning station in which unsecured fibers are removed from between the brush bristles before the belt returns to the fiber laying station.

Engaging the exposed ends of the fibers may involve supporting the first carrier sheet on the exposed ends while the fibers are held between the brush bristles.

In some examples, permanently securing the engaged ends of the fibers to the first carrier sheet involves heating the engaged ends of the fibers with heat applied through the first carrier sheet, and/or heating the exposed ends of the fibers before engaging the exposed ends of the fibers with the side of the first carrier sheet.

As discussed herein, the extruded resin fibers may be hollow, may each have one or more extrusion seams extending longitudinally along the fiber, and/or may be of different thicknesses. Preferably the fibers, as oriented, are straight, uncrimped, staple fibers of length between 4 and 10 mm. Preferably the staple fibers have a nominal thickness of between 50 and 250 microns, and/or a length to thickness ratio of between 10 and 60.

In some instances, the first carrier sheet has a nominal thickness between 0.3 and 2.5 times a nominal thickness of the fibers.

In some applications, the second carrier sheet has a film forming the surface of the second carrier sheet (or even forming the entire second carrier sheet). Securing the distal ends of the fibers to the surface of the second carrier sheet comprises welding resin of the fibers directly to resin of the surface of the second carrier sheet.

In some examples, the fibers are bicomponent fibers having a core of a first material and a sheath of a second material (such as different resins).

Another aspect of the invention features a method of making a spacer product that involves applying an adhesive to a surface of a first carrier sheet, flocking elongated stems onto the surface (the flocked stems aligned such one end of each aligned stem is secured by the adhesive to the first carrier sheet and an opposite end of each aligned stem is spaced from the adhesive, such that the flocked stems extend outward from the first carrier sheet), and securing the opposite ends of the stems to a side of a second carrier sheet, such that the stems space and separate the first and second carrier sheets.

Yet another aspect of the invention features a method of making a flexible spacer product, which involves orienting a number of fibers in a common direction, with an end of each fiber exposed and the fibers overlapping in length, each fiber comprising a core of a first material surrounded by a sheath of a second material, engaging the exposed ends of the fibers with a side of a first flexible carrier sheet, permanently securing the engaged ends of the fibers to the first carrier sheet by welding the sheaths of the fibers to the first carrier sheet (forming a precursor sheet with the fibers having distal ends spaced from the first carrier sheet), securing the distal ends of the fibers to a surface of a second flexible carrier sheet, such that the fibers hold the first and second carrier sheets in a spaced relation to form a spacer product, and forming apertures extending from one broad side of the spacer product to an opposite broad side of the spacer product, each aperture extending along an interior channel within a respective one of the welded sheaths.

In some examples, forming the apertures involves removing at least some of the core of each fiber. For example, removing at least some of the core of each fiber may involve dissolving the first material in a solvent to which the first material is more susceptible than the second material, or radiating the spacer product with radiation that selectively softens the first material. Forming the apertures may involve removing essentially all of the core of each fiber.

In some cases, permanently securing the engaged ends of the fibers to the first carrier sheet causes the cores of the fibers to embed into the first carrier sheet, such as so as to pierce through the first carrier sheet and become exposed on a side of the first carrier sheet opposite the fibers.

In some embodiments, orienting the fibers involves holding the fibers between bristles of a brush, with the fibers parallel to the bristles.

Securing the distal ends of the fibers to the surface of the second flexible carrier sheet involves, in some cases embedding the distal ends into the second carrier sheet, such as so as to pierce through the second carrier sheet and become exposed on a side of the second carrier sheet opposite the fibers.

In some cases, the first material is a metal wire.

Forming the apertures may involve removing at least some of the core of each fiber.

Another aspect of the invention features a method of filtering a flow of fluid. The method involves arranging the spacer product described herein within a flow passage, with the stems oriented across a direction of flow defined by the passage, and causing the flow of fluid to flow along the spacer product between the carrier sheets, such that particulates entrained within the flow are filtered out of the flow by the stems. The fluid may be, for example, a liquid or a gas.

Another aspect of the invention features a method of supplying irrigation to living plants. The method includes providing the spacer product described herein (but with at least one of the carrier sheets of the spacer product being liquid-permeable), arranging the spacer product such that a liquid-permeable carrier sheet of the spacer product faces a root growing volume, and supplying irrigant (such as water) to a space between the carrier sheets of the spacer product, such that the irrigant flows through the liquid-permeable carrier sheet and into the root growing volume.

In some cases, the method also includes placing soil in the root-growing volume and planting seeds or seedlings in the soil.

The liquid-permeable carrier sheet may be or include a non-woven material, for example.

The methods taught herein may be employed to make particularly light and inexpensive spacer products that can provide, in various configurations, good insulation, shock absorption, fluid transport and filtration and other characteristics. The manufacturing method may be performed at high speeds to produce a product that is very material-efficient, and may be readily adapted to make spacer products of different properties.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a photograph of a spacer product.

FIGS. 2A and 2B are enlarged edge views of the spacer product.

FIG. 3 is a microphotograph of a precursor product.

FIG. 4 is an enlarged perspective view of a distal end of a fiber of the product of FIG. 3.

FIG. 5 is a microphotograph of a stem base, as severed along a plane perpendicular to the film.

FIGS. 6 and 7 are enlarged views of the film surface, including several stem bases.

FIG. 8 is a microphotograph of a precursor product with bent fibers.

FIG. 9 is an enlarged view of the product of FIG. 8.

FIG. 10 is an enlarged edge view of a spacer product with bent spacer fibers.

FIG. 11 illustrates a machine and process for forming precursor products.

FIGS. 12A-12D sequentially illustrate needling staple fibers into a brush.

FIGS. 13A and 13B are enlarged edge views of spacer products with carrier sheets having non-woven materials.

FIG. 14 shows shaking fibers into a brush.

FIG. 15 shows injecting fibers into a brush.

FIG. 16 shows drawing fibers into a brush.

FIG. 17 shows a process of making a spacer fabric, featuring electrostatic flocking.

FIGS. 18A-18D sequentially illustrate fusing a stem to a sheet and forming an open passage along the stem through the sheet.

FIGS. 19A-19F sequentially illustrate forming a spacer fabric by joining two sheets with sheaths around non-resin stem cores.

FIG. 20 is a perspective view of a flexible skin patch.

FIG. 21 is a cross-sectional view, taken along line 21-21 of FIG. 20.

FIG. 22 is an enlarged view of a portion of the patch of FIG. 21, showing medicament between the stems.

FIG. 23 is a partial cross-sectional view through a portion of a bicycle helmet.

FIG. 24 illustrates irrigation into soil using spacer fabric.

FIG. 25 illustrates hydroponic irrigation using spacer fabric.

FIG. 26 schematically illustrates a filter formed as a stack of spacer fabric layers.

FIG. 27 shows a filter cartridge made of coiled spacer fabric.

Like reference symbols in the various drawings indicate like elements.

### DETAILED DESCRIPTION

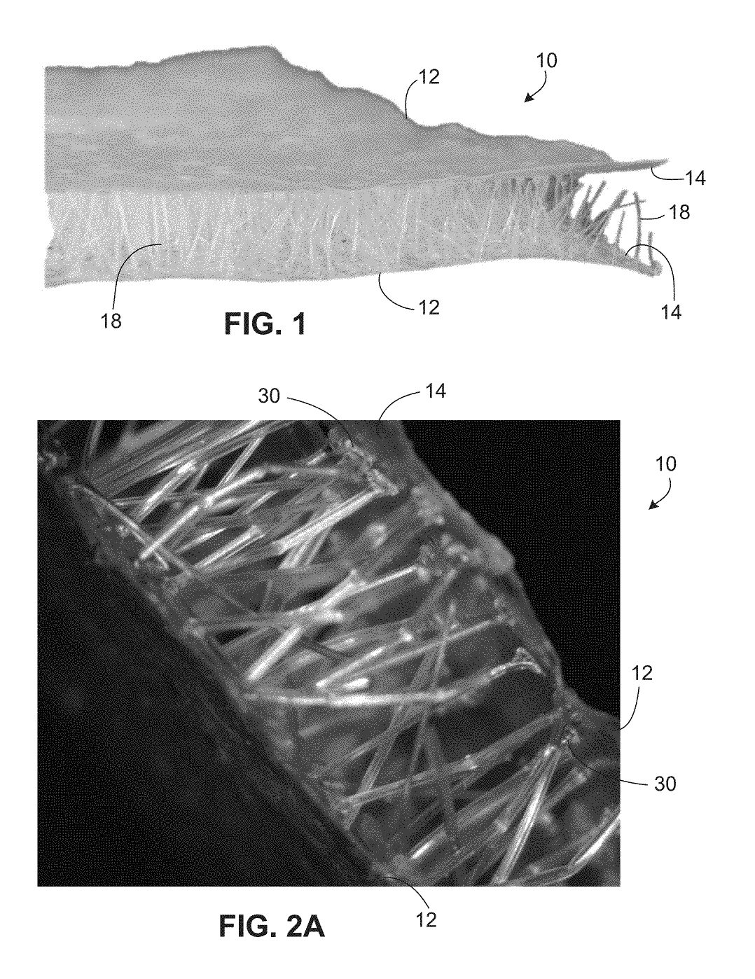

Referring first to FIG. 1, a spacer fabric 10 includes, or in many cases consists essentially, of two carrier sheets 12 connected and spaced apart by a field of interconnecting stems 18. Each carrier sheet 12 has a side surface 14 facing the other sheet and which in this example is formed by a resin film. The non-tapered stems 18 are of resin and extend from one side surface to the other, and as will be discussed in more detail below, are secured to the side surfaces by discrete welds. As seen in this figure, the stems 18 extend generally perpendicularly to the carrier sheets. However, the stems extend at different angles, with some essentially vertical and others leaning, and still others with noticeable bends. As will be discussed in more detail below, the stems have a particularly high length to thickness ratio, meaning that they are relatively tall and slender, and are of generally constant cross-section, meaning that the cross-section of the stem stays generally constant over its length and not, for example, tapering in thickness. As will be evident in this and other photographs, the stems are not arranged in an ordered pattern or array, but are of a pseudo-random distribution. By ‘pseudo-random’ we mean that the distribution is apparently random to visual observation. This does not preclude slight patterning as a residual effect of patterning, such as by needling, but distinguishes structural patterning such as weave or knit patterns or repetitive molding patterns.

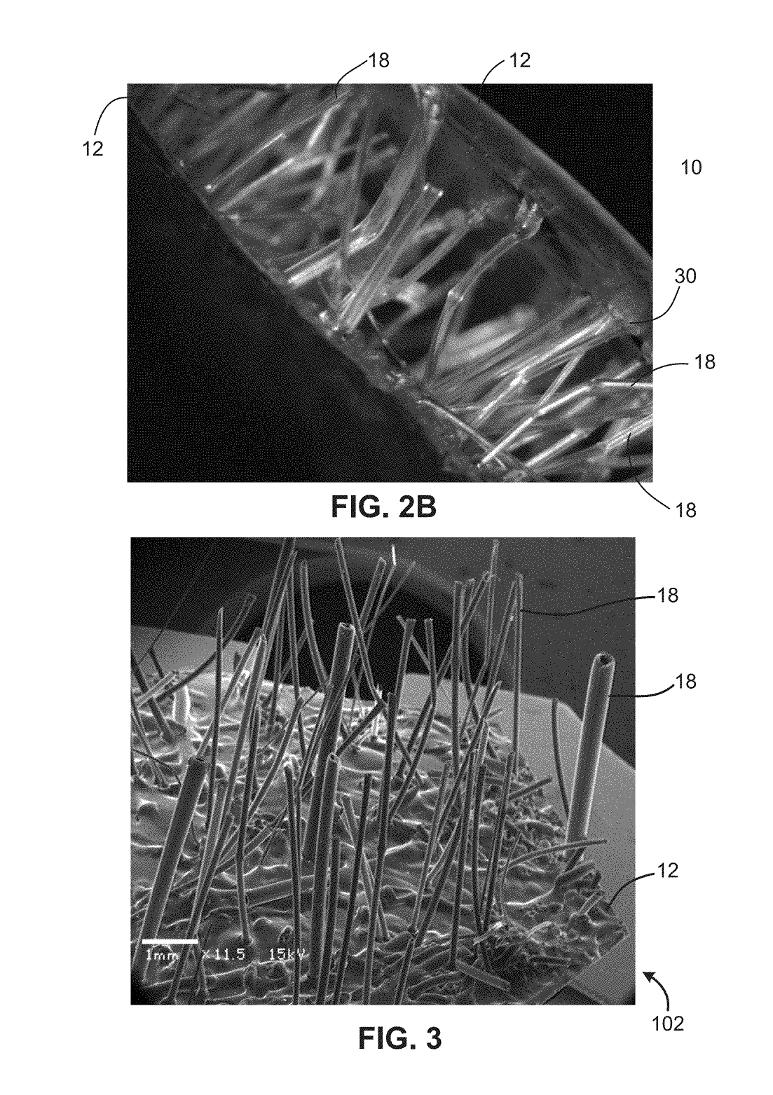

Referring also to the more enlarged views of FIGS. 2A and 2B, the films forming the carrier sheets 12 in this example are particularly thin in comparison with the thickness of the stems, and the discrete welds 30 joining the individual stems to the films are enlarged with respect to the stem thickness. The stems each have a length, measured along the stem from one carrier sheet to the other, and an overall lateral thickness, measured perpendicular to the stem. In many cases, such as the example illustrated in FIG. 2A, the stems have a length to thickness ratio of at least 10, or between 10 and 60. The stems shown in FIG. 2A, for example, have a typical length of about 4.2 mm and a nominal thickness of about 0.15 mm, resulting in an L/T ratio of around 30 and an overall product thickness below 5.0 mm (and in this case, about 4.2 mm). Not all of the stems within the spacer fabric are connected to both sheets, nor even span the full distance between them, but a sufficient proportion of the stems are each connected to both carrier sheets 12 that the spacer fabric is dimensionally stable and the sheets may not be pulled apart with resulting damage.

Spacer fabric 10 may be produced from one or two precursor sheets 102, as shown in FIG. 3. Stems 18 of this example precursor product 102 have straight distal ends and are generally of the overall shape of drinking straws. As evident in FIG. 3, these stems may be of different diameters. At least many extend to a similar, although not identical, height from carrier sheet 12. The topography of the side surface of the carrier sheet is affected by portions of stems that have melted into the surface of the film as a result of the manufacturing process, described below. This example was produced needling fibers into a brush having bristles substantially longer than the staple fibers—in this case needling 6 mm fibers into a 20 mm deep brush.

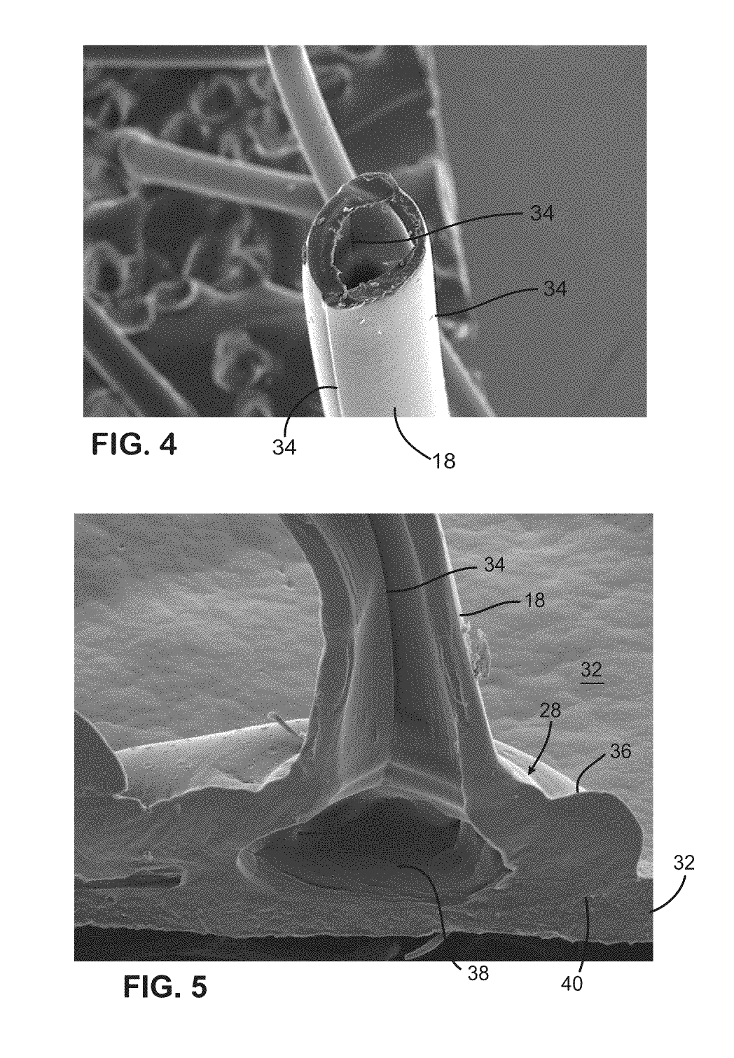

Referring also to FIG. 4, each stem 18 is tubular and hollow over a majority of its length, with a generally cylindrical outer surface. However, the tubular stems each have extrusion seams 34 extending longitudinally along the stem. In this example, the stems each have three generally equidistant seams 34. That the seams 34 extend along the entire length of stems 18 is evident also from FIG. 5, as is the formation of the weld puddle 36 at the base 28 of the stem. In this instance a cavity 38 developed within the weld puddle, open to the interior of the hollow stem. The weld line 40 between the stem resin and the film resin is also evident in this photograph, as well as that the nominal film thickness in this case is less than the overall thickness of the stem. The slight splaying of the bottom end of the stem, and the expanded puddling of the stem resin are believed to result from the base end of the stem being subjected to a nominal columnar load during the welding process. Even with such minor splaying at the ends, and the formation of weld puddles at the carrier sheet, the stems are and remain essentially non-tapered along their overall length.

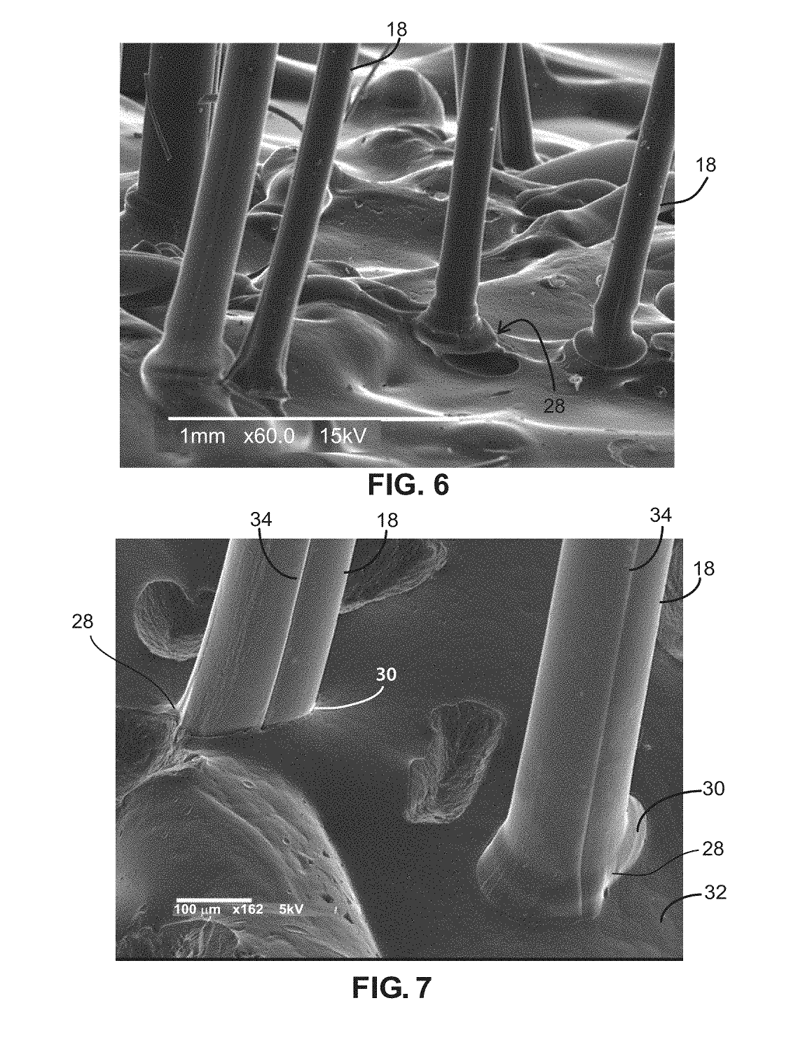

Referring also to FIG. 6, the expansion of the base end of the stem, combined with the weld puddling, we have come to refer to as the ‘elephant foot’ effect. This can also be called a ‘melt buckling’ effect, the result of which is to produce a base 28 having an expanded footprint on the film, for increased weld area and better securement of the stems to the film. Evidence of the melt buckling can be seen in the slight diameter fluctuations at some of the stem bases. As seen in FIGS. 5 and 6, at least many of the welds produced at the bases of the stems have a lateral extent, at the side of the resin film, of at least twice the nominal thickness of the stems themselves.

Referring next to FIG. 7, the stems 18 have bases 28 that are secured to the side surface of the film at the weld points 30 in which resin of each stem is solidified in a weld with resin of the film 32. How this welding is accomplished with such thin stems and thin film is discussed in more detail below. In many instances the weld is in the form of a solidified puddle of resin disposed above the generally planar film surface, as seen in FIG. 5. In other instances, the weld forms less of a discrete puddle above the film, as in the example shown in FIG. 7. In some cases, holes may be formed in the film during the formation of the welds.

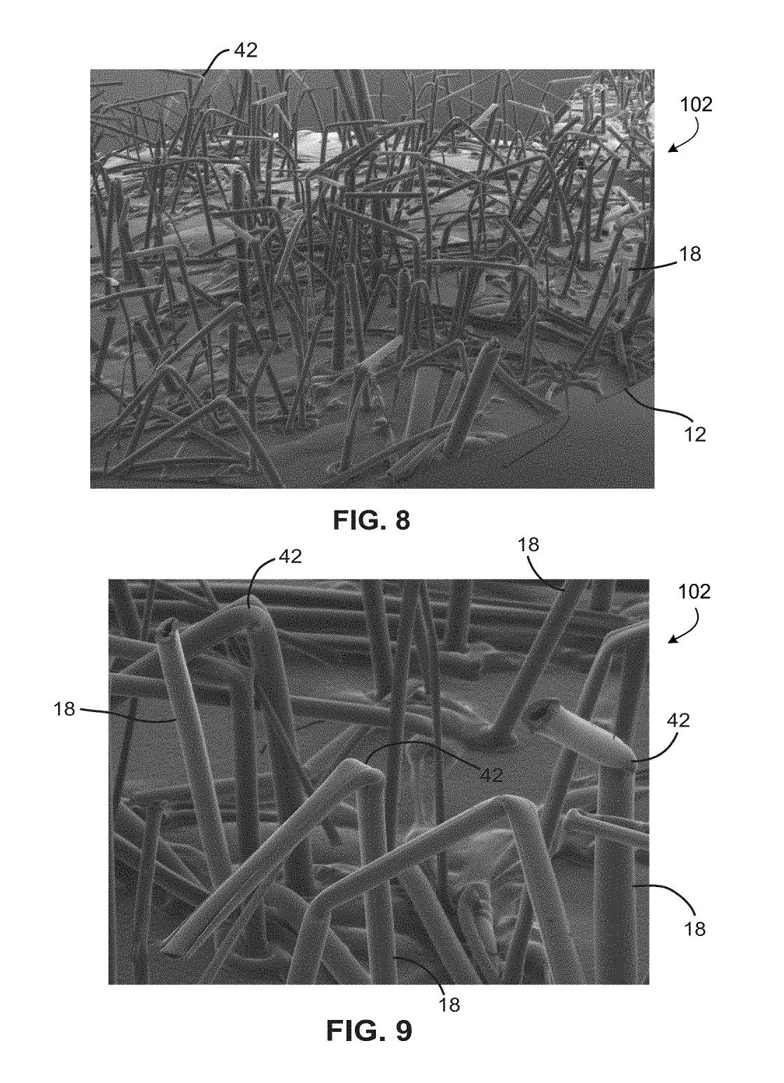

As seen in FIGS. 8 and 9, in some instances many of the stems 18 of the precursor sheet each have a defined and discrete bend 42, with the bends located at a generally common distance from the base. In many cases the bent stems are straight other than at the single bend, often near a midpoint of the length of the stem. These images are provided to illustrate that in many cases it is not necessary for the precursor stems to be straight prior to formation of the spacer fabric. This example was produced needling fibers into a brush having a bristle bed only about as deep as the length of the stable fibers—in this case, needling 6 mm fibers into a brush of only 6 mm long bristles. In other words, useful product was produced even needling fibers in such a way that the fiber did not align vertically over substantially its entire length within the brush before fusing to a backing.

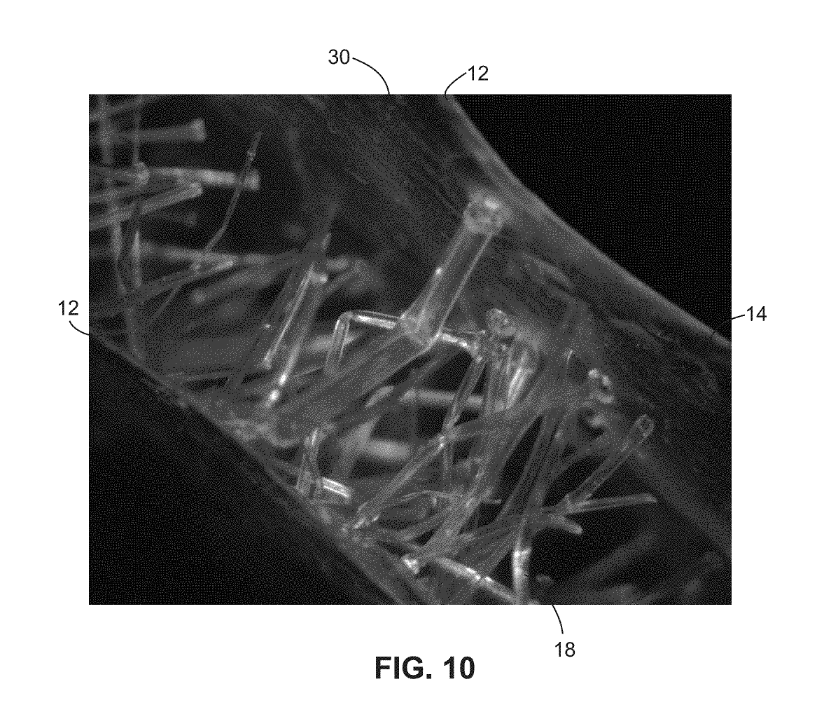

Referring also to FIG. 10, the stems 18 of the completely assembled spacer fabric may feature bends, either from bends formed in the formation of the precursor sheet(s) or caused by some buckling of the stems during joining of the two sheets together. FIG. 10 also illustrates that not all stems 18 need span the full distance between sheets 12. Even with only a significant proportion of stems welded to the spaced apart sheets at both ends, the resulting spacer fabric 10 is particularly stiff. Two precursor products 102 can be joined to produce a single spacer fabric 10, by intermeshing their stems and fusing the stems of each product to the carrier sheet of the other product. The intermeshed stems extending between the films form a tortuous path from one edge of the fabric to another.

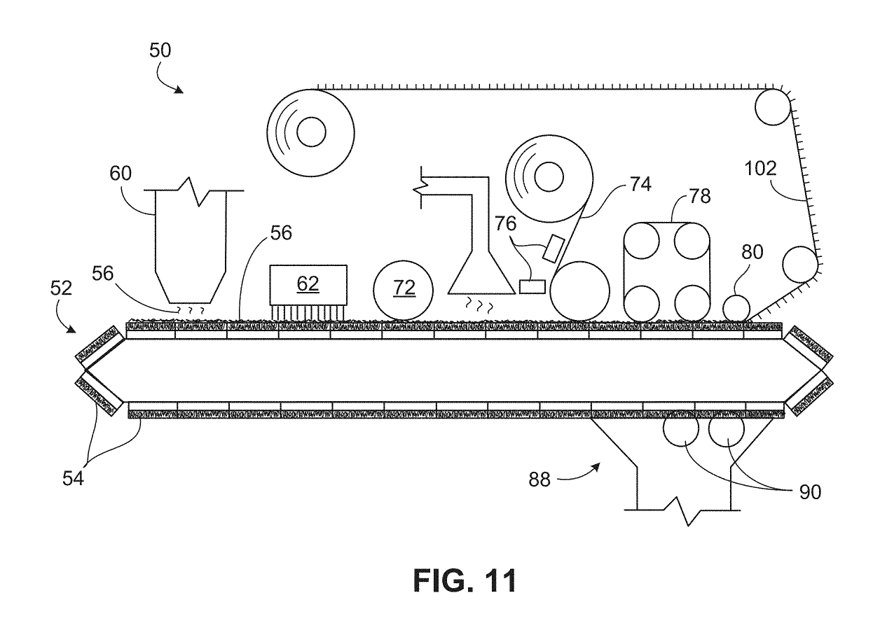

Referring next to FIG. 11, a machine 50 and process for producing the precursor product described above features a continually moving brush apron 52 comprised of rigid brush segments 54 linked to form a continuous loop. Each segment carries a dense bed of upstanding flexible bristles extending from a rigid base. As shown, brush apron 52 is maintained to travel at a constant line speed along a linear path through various stations of the manufacturing process. In some embodiments, brush apron 52 has a nominal bristle density of about 2500 bristles per square inch (about 380 bristles per square centimeter). The bristles are each about 0.008 inch (0.2 millimeter) in diameter and about 6 millimeters long (although 20 mm long bristles have also been successfully used), with rounded tips. The bristles used to produce the products illustrated above are crimped, with a crimp period of about 5 mm and a crimp amplitude of about 0.5 mm. The bristles may be formed of any suitable material, for example 6/12 nylon. Suitable brushes may be purchased commercially and retrofitted onto supporting links. Generally, the brush apron moves at the desired line speed.

Beginning at the lower left end of FIG. 11, a loose batt 56 of staple fibers 58 is air laid on the brush apron, such as from an air chute 60. The fibers, as laid on the velour brush apron, are randomly distributed and randomly oriented and form a batt of only about 200 grams per square meter (gsm). The staple fibers are uncrimped, hollow fibers, each having a nominal length of only about 6 mm, and are completely disconnected and loose in the batt. The batt 56 has virtually no strength or coherence in any direction because the fibers are not entangled or otherwise tethered. Thus, the batt is an “incoherent” layer of staple fibers, having little to no dimensional stability in any direction, and will pull apart under its own weight if attempted to be lifted from the brush apron at this stage.

In some embodiments, suitable fibers 58 are drawn and uncrimped fibers, 40 to 200 denier, of about 4 mm to 10 mm staple length, preferably hollow. For the example shown in FIG. 3, polypropylene 70 dtex hollow fibers, cut to 6 mm length, were obtained from IFG Asota of Linz, Austria, as an uncrimped variant of their product G40B2, cut to a 6 mm staple length. Such fibers are believed to be extruded from spinnerets having multiple curved orifices separated by thin walls, such that extrudate from the adjacent orifices join immediately after or during extrusion to form the seams. In the case of the stem shown in FIG. 4, for example, each spinneret would have three arc-shaped nozzle openings arranged in a circle. Envisioned modifications to alter the resulting structure of the fiber (which becomes the stems in the fastener product) include altering the distance between adjacent nozzle openings, or altering the number of openings spaced about the perimeter to change the number of resulting seams. The shapes of the orifices may also be altered to create a fiber (stem) of non-circular outer circumference, or a different inner surface configuration, both to change the structural properties of the stems and to create different head shapes. Various synthetic fiber materials may be employed, understanding that formation of the heads is affected by the amount of residual draw or longitudinal strain in the fibers as laid on the brush apron. It may even be advantageous to use bicomponent fibers, either of one resin sheathed with a second resin or of alternating longitudinal segments of two resins, either solid or hollow. The fibers 58 may be of different thicknesses or otherwise of different construction, but preferably all of the fibers are of drawn resin suitable for head formation, as discussed below, for efficient use of materials.

Stem fibers with tenacity values, measured in accordance with test method ISO 5079, of at least 5 cN/tex are preferable, and fibers with a tenacity of at least 10 or more cN/tex (preferably even 15 or more cN/tex) are even more preferred in many instances. In general terms, the higher the fiber tenacity, the stronger the fastener element stem. For many applications, particularly products where the hook-and-loop components will be engaged and disengaged more than once (“cycled”), it is desirable that the stems have relatively high strength so that they do not break when the fastener product is disengaged. Widespread stem breakage can deleteriously effect re-engagement of the fastener.

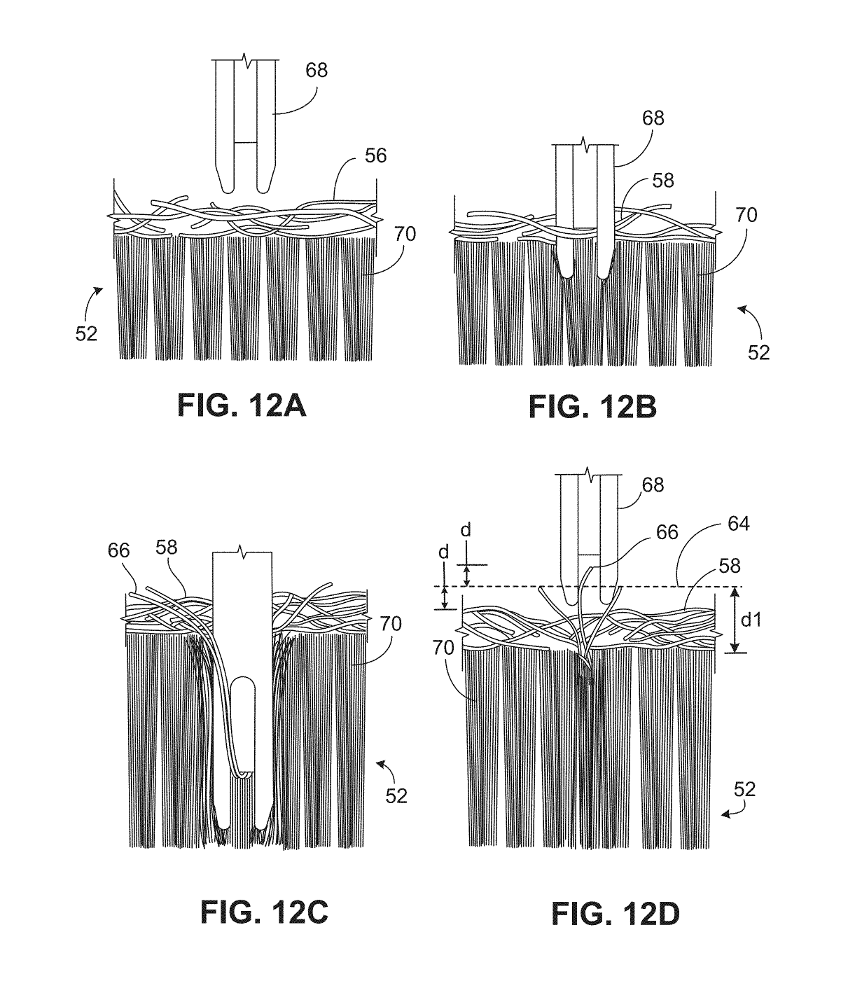

Referring again to FIG. 11, fiber batt 56, in its incoherent state, is carried by brush apron 52 into a needling station 62, where the batt of fibers is repeatedly needle-punched. The needles may be guided through a stripper plate above the fibers, and draw fibers of the batt deep into the brush apron on the other side. During needling, batt 56 is supported directly on the bristles of brush apron 52 (as shown in FIGS. 12A-12D), which moves with the fibers through needling station 62. In some embodiments, needling station 62 needles the batt with an overall penetration density of about 80 to 320 punches per square centimeter, using forked needles 68. In a particular example, needle beams are fitted with needle boards having a density of 7500 needles/meter. In this example, the needle loom was fitted with 36 gauge, 2.5 inch needles and cycled with a stroke frequency of 2100 strokes per minute.

FIGS. 12A through 12D sequentially illustrate the displacement of fibers deep into the brush apron by the needling process. Initially, the loose batt 56 of fibers is conveyed to the needling station by brush apron 52, with the individual fibers 58 of the batt carried directly on a bed of brush bristles 70 (FIG. 12A). As a fork needle 68 enters the batt (FIG. 12B), some individual fibers 58 will be captured in the cavity between the leading prongs of the forked end of the needle. As needle 68 “punches” into the brush, these captured fibers 58 are drawn down with the needle into the bed of bristles 70. As shown, the remainder of the batt remains generally supported on brush apron 52 through this process. Thus, the penetrating needle 68 laterally displaces local brush bristles 70 as it intrudes upon brush apron 52. As needle 68 continues to penetrate (FIG. 12C) through brush bristles 70, the captured fibers 58 are drawn deep into the brush and out of the batt. In this example, a total penetration depth of up to about 4 millimeters, as measured from the top surface of brush apron 52, was found to draw most of the captured fiber into the brush, leaving only exposed fiber ends, either extending from, or level with, the top surface of the brush. We have found that the needling depth can be somewhat greater than the staple fiber length and still produce useful product. When needle 68 is retracted from the bristle bed (FIG. 12D), the captured fibers 58 carried into the brush bristles 50 remain in place with an essentially vertical orientation between the bristles. It should be understood that other needle types may be used; for example, felting needles or crown needles.

Where necessary, an elliptical needling technique (such as described in U.S. Pat. No. 7,465,366 the entirety of which is incorporated herein by reference), or similar, can be used to reduce or eliminate relative movement between the batt and the penetrating needles.

For needling longitudinally discontinuous regions of the material, such as to create discrete regions of fastening elements, the needle boards can be populated with needles only in discrete regions, and the needling action paused while the material is indexed through the loom between adjacent loop regions. Effective pausing of the needling action can be accomplished by altering the penetration depth of the needles during needling, including to needling depths at which the needles do not penetrate the batt. Such needle looms are available from Autefa Solutions in Austria, for example. Alternatively, means can be implemented to selectively activate smaller banks of needles within the loom according to a control sequence that causes the banks to be activated only when and where fastener elements are desired. Lanes of fastener elements can be formed by a needle loom with lanes of needles separated by wide, needle-free lanes.

Thus, unlike typical needling processes in which the purpose and function of the needling is to entangle fibers within the batt, or to form discrete loops of fiber extending into the brush while leaving ends of the fibers on top of the brush, this needling process drives a significant portion (generally, about 25 percent or more) of the fiber into the brush, leaving ends of individual fibers extending upward from between the brush bristles 70. As illustrated in FIG. 12D, as a result of the needling fibers are left oriented in the vertical direction (normal to the batt), with at least one end 66 of each fiber exposed and positioned within a distance ‘d’ of datum 64. Preferably, the distance ‘d’ is less than 20 percent of the average or nominal length of the staple fibers. For example, for 6 mm staple fibers, the needling results in many fiber ends 64 being within 1 mm of a common datum above the surface of the brush. The result of the needling is that the nominal distance dl that the fiber ends extend from the brush (represented by datum 64) is in some cases about 2 mm, such that the majority of each of the embedded fibers is primarily between the brush bristles 70. Prior to vacuuming the remaining fibers from the surface, the exposed ends may be difficult to see.

Referring back to FIG. 11, after needling the exposed ends of the needled fibers may be processed by a roller 72 that helps to further normalize the distance to which the fiber ends extend above the brush surface, further diminishing the distance dl that datum 64 for is above the brush (see FIG. 12D). In some cases, after adjustment by roller 72, datum elevation d1 is only about 0.3 mm, or even zero. As an alternative to roller 72, a flat plate or flat belt laminator can be used to press the fibers further into the brush. After roller 72, any loose (excess) fibers are vacuumed from the brush surface, leaving essentially only those fibers that have been oriented vertically within the brush, generally with exposed ends extending a nominal distance (d1, FIG. 12D) from the brush. For example, of the 200 gsm of fibers initially forming the batt prior to needling, vacuuming may remove 140 gsm of fiber, with another 10 gsm of fiber subsequently removed from the brush after removal of the product—meaning that only 1/4 of the original fiber mass (or 50 gsm, in this case) is incorporated into the final product. A film 74 is then introduced to the exposed fiber ends (and to the tops of the bristles if the fibers have been depressed to be fully within the brush) and the film fused to the exposed ends of the fibers. Immediately before introduction of the film, either or both of the film surface and the fiber ends are softened by heat from a radiant heater 76. Immediately after the film is introduced, pressure is applied to the fiber ends through the film, such as by a pressure belt 78 that travels with the brush apron to apply a desired, non-sliding pressure to the film for a desired dwell time, to effect the fusing. Belt 78 may be heated, such that heat is applied by the belt, through the film, to the fiber ends, either additionally, or as an alternative, to preheating the fiber ends and/or film. In any case, it is a combination of heat and pressure over time that causes the ends of the fibers to weld to the film. Belt 78 may be equipped with multiple sequential heating and cooling zones to affect different heating conditions as needed to effect the desired bonding, depending on thicknesses, speeds and materials, such as is taught in U.S. Ser. No. 14/725,420, filed May 29, 2015, the contents of which are incorporated herein by reference. However, formation of the precursor products shown in FIGS. 3-9 required only a single pressure/heating cycle, using a heating plate of temperature of about 400 degrees F., pressed against the back of the film with a pressure of about 0.09 psi and held in place for about 1 second. As noted above, in some cases holes are formed in the film during processing, typically during the fusing of the film to the fibers. In some cases, the film can partially fuse also to tips of the bristles, such that when the film is later removed small amounts of film material are removed from the surface, leaving divots or craters (such as craters 35 seen in FIG. 7). Such craters are not found to have any detrimental effect on the performance of the fastener product. Cratering may be reduced by lowering pressure and/or temperature of the fusing process, or by coating the bristle tips.

Film 74 may be, for example, a 45 gsm, 0.05 mm thick film, such as of polypropylene if working with polypropylene fibers. Preferably the film and fibers are of the same base resin, to promote welding. We have found that this process can successfully fuse fiber ends to film even when the film is of the same thickness as, or even thinner than, the rather thin fibers. In the fusing process, there is evidence of melting of both the film and the fiber at the weld points.

Following fusing, the precursor fastener product 102 (film and fused fibers) is removed from brush apron 52 via tension applied by a stripper roll 80, which pulls the oriented fibers from the bed brush bristles. Removed from brush apron 52, the precursor product has a base formed predominantly of film but incorporating random portions of fiber that had remained on the brush surface, and a bunch of fibers fused to, and extending from, the base as shown in FIG. 3. This precursor product 102 is either spooled for later processing, or fed directly into a joining station where either a separate carrier sheet/film or another precursor product is permanently joined to the distal ends of the stems to form the spacer fabric.

After the precursor product has been stripped from the brush apron, the brush segments are cleaned of any remain fiber at a cleaning station 88, in which hook rolls 90 agitate the brush surface in the presence of a cleaning air flow. Removed fibers may be recycled into the process.

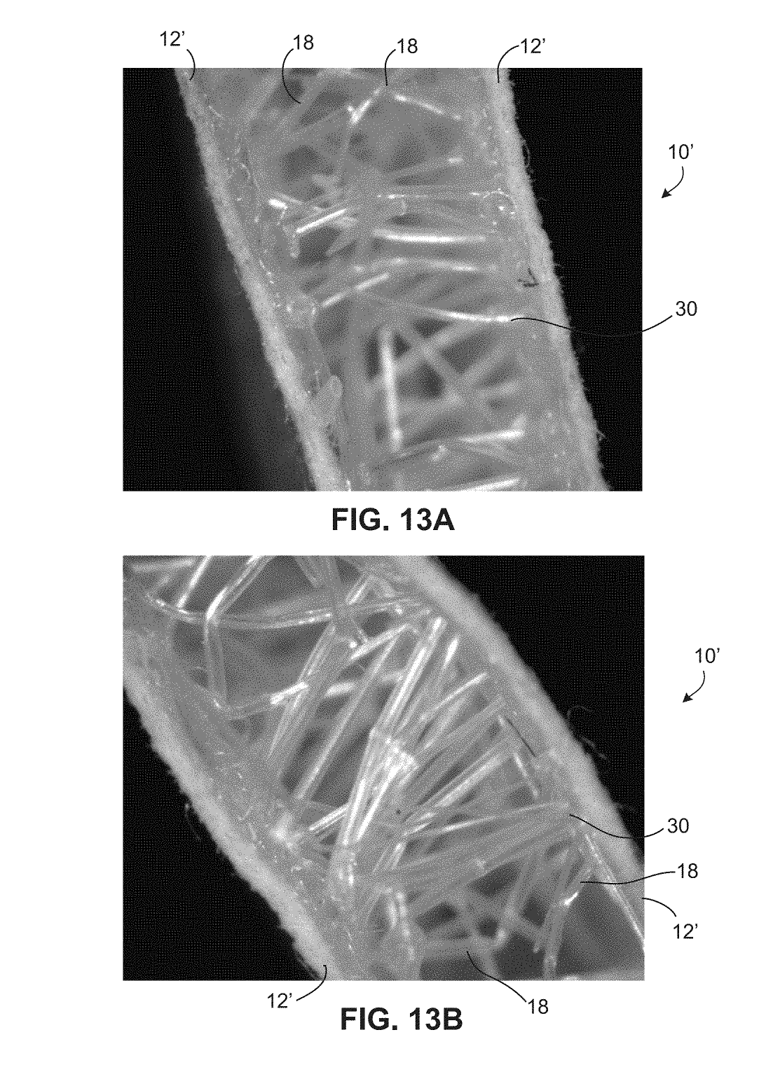

In some cases, a material other than film can be used to form the base of the precursor product, or either carrier sheet of the spacer fabric. For example, a light non-woven material can be fused onto the exposed fiber ends to form a porous base from which the stems extend. In another example, the loose fibers of the batt are left on the brush surface and fused together (and to the exposed fiber ends) to form the product base. Other suitable carrier sheets include other films, such as elastomeric or stretchable films, non-woven materials, and paper. Referring to FIGS. 13A and 13B, another example of a spacer fabric 10′ has stems 18 as in the above examples but connecting carrier sheets 12′ that are sheets of Invista FF103 spunbond polyethylene non-woven material having a basis weight of 75 gsm. The fiber ends were fused directly to the polyethylene fibers of the non-woven sheets to hold the spacer fabric together, using the process described above for fusing to film. The resulting spacer fabric 10′ is permeable, allowing passage of air to/from the space between the sheets through the sheets. In another example (not illustrated), the fibers are fused to a film forming one side of the spacer fabric (as in the example of FIG. 2A, and to a non-woven material forming the other side of the spacer fabric (as in the example of FIG. 13A). Sheet permeability can be put to advantage in several applications, as described below.

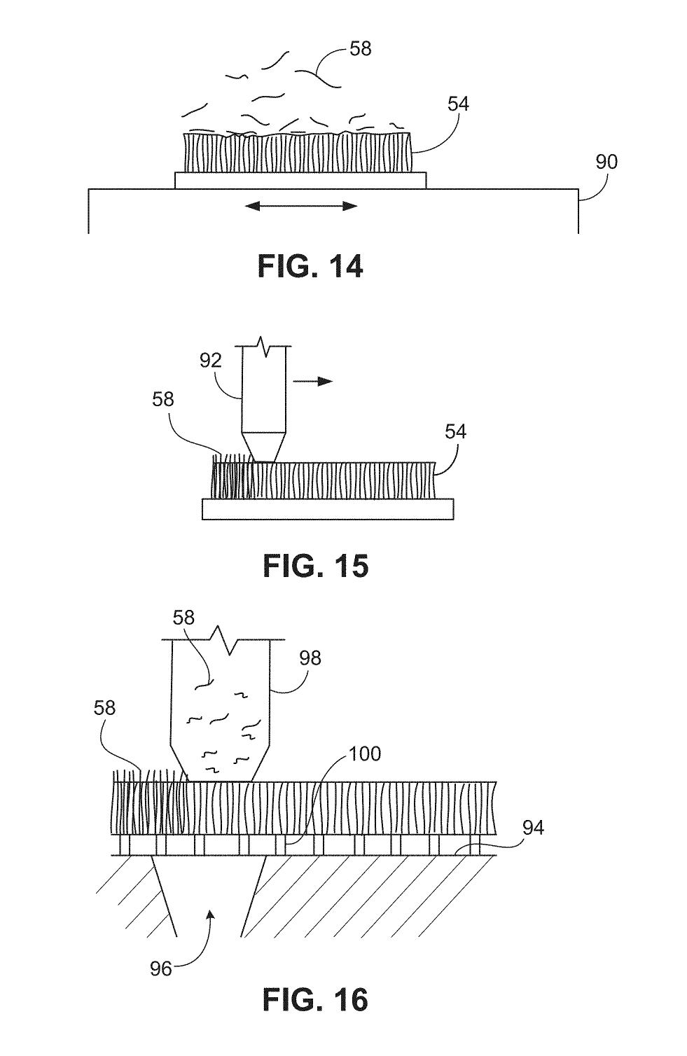

Regarding the initial positioning/orientation of fibers in the brush, deep between the bristles, other methods may be employed as an alternative to needling. For example, FIG. 14 conceptually illustrates motivating discrete staple fibers into a brush segment 54 using vibration applied to the brush segment by a shaker table 90 that vibrates the brush segment laterally as the fibers are introduced to the surface of the brush. By selecting a vibration frequency in connection with the structural properties of the brush bristles, transient openings may be formed between bristles in order to receive fibers that penetrate farther into the brush and become vertically oriented between bristles as a result of the vibration. FIG. 15 conceptually illustrates ejecting fibers into the brush by means of a pneumatic nozzle 92 that orients the fibers vertically and drives them into the brush as the nozzle moves across the brush surface. The nozzle tip may be configured to engage and separate the bristle tips to facilitate fiber injection. The nozzle is connected both to a source of pressurized air flow and to a source of fibers, such that the fibers are entrained in a flow of air introduced to the nozzle. FIG. 16 conceptually illustrates pulling discrete staple fibers into a brush segment supported on a vacuum table 94. As the brush segment moves across the table under a hopper 98 of loose fibers (or other fiber source) aligned with a vacuum port 96 in the table, air is drawn from the hopper, between the brush bristles, through apertures in the base of the brush segment, and into the vacuum port 96, carrying fibers 58 from the hopper into the brush and orienting them vertically between the bristles. The lower end of hopper 98 may be configured to splay the bristles as the brush passes beneath, facilitating fiber placement.

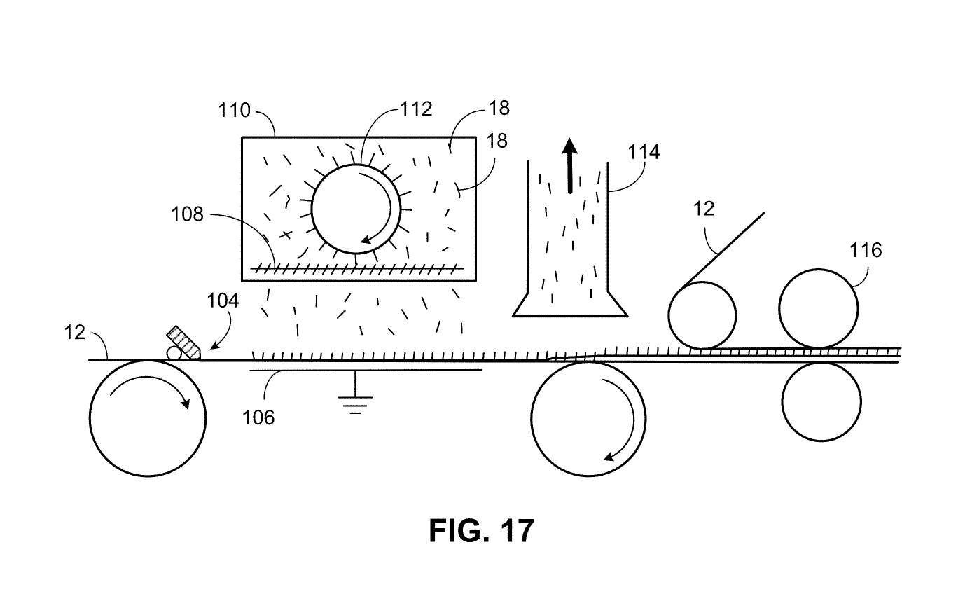

Another method of forming a precursor product and from that precursor product a spacer fabric is illustrated in FIG. 17. In an electrostatic flocking process, adhesive 104 is first applied to an upper side of a carrier sheet 12, such as a film, and the adhesive-coated film is conveyed between a ground plate 106 and an electrically charged plate 108 at an outlet of a hopper 110 in which an agitator 112 separates and churns loose fibers 18. Electrostatic charge of the fibers aligns and propels the loose fibers toward the ground plate in the presence of the electric field between the two plates, to adhere to the adhesive with a substantial number of the fibers extending away from the carrier sheet at various angles. A vacuum 114 draws loose fibers from the sheet before a second carrier sheet 12, such as another film, is draped onto the exposed, distal ends of the fibers and subsequently fused to the fibers by transient application of heat and light pressure by roller 116.

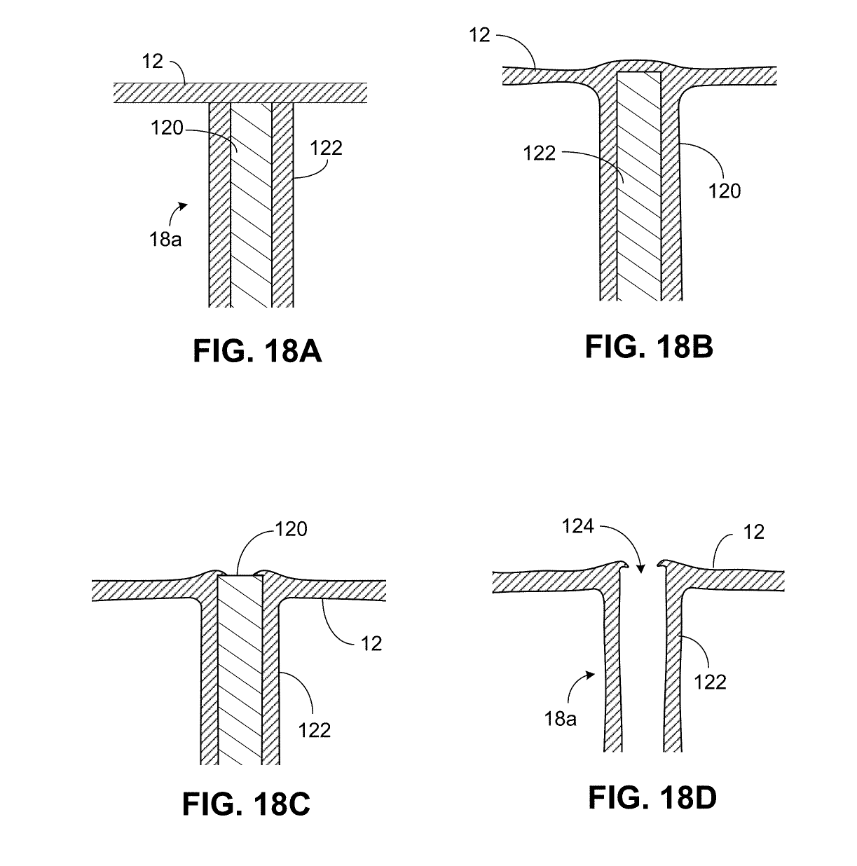

FIGS. 18A-18D sequentially illustrate one method of forming a forming a spacer or other product with hollow fibers connecting spaced carrier sheets and forming passages through the product. In this example fiber 18a is a bicomponent fiber with a core 120 of one resin surrounded by a sheath 122 of another resin. The sheath resin is selected to be fuse-compatible with the resin of carrier sheet 12 (e.g., of the same base resin as that of the sheet), while the core resin is selected to be relatively unaffected by the fusing of the sheath to the carrier sheet, but to be later removed to leave an aperture through the product. Referring first to FIG. 18A, carrier sheet 12 is first positioned to rest on the distal end of fiber 18a (as in the process described above). The carrier sheet 12 and sheath 122 are then fused (e.g., welded) to form a contiguous resin mass (FIG. 18B). This can be by applying heat (such as by flame or heated roller or platen) through sheet 12 as discussed above. In the fusing process, the unaffected core 120 embeds within the thickness of the sheet, and preferably the heating continues until the end of core 120 is exposed on the opposite side of the sheet, as shown in FIG. 18C. Final exposure of the core may be aided by the drawing back of the thin residue of the sheet, under the effect of surface tension or molecular attraction and wicking. The stiffness of the solid core fiber also aids in the penetration of the sheet material. In a subsequent step, the core 120 is removed, such as by applying or submerging the product in a solvent that dissolves the core while leaving the sheet and sheath intact, leaving a passage 124 extending through sheet 12 and along the now hollow fiber 18a.

As an alternative to applying heat through sheet 12, fusing of the sheath and exposure and subsequent removal of the core resin can be accomplished by applying RF energy at a frequency that selectively heats the core, with heat from the heated core locally melting and fusing the sheet and sheath. The core itself is eventually sufficiently heated to melt and can be blown out of the product.

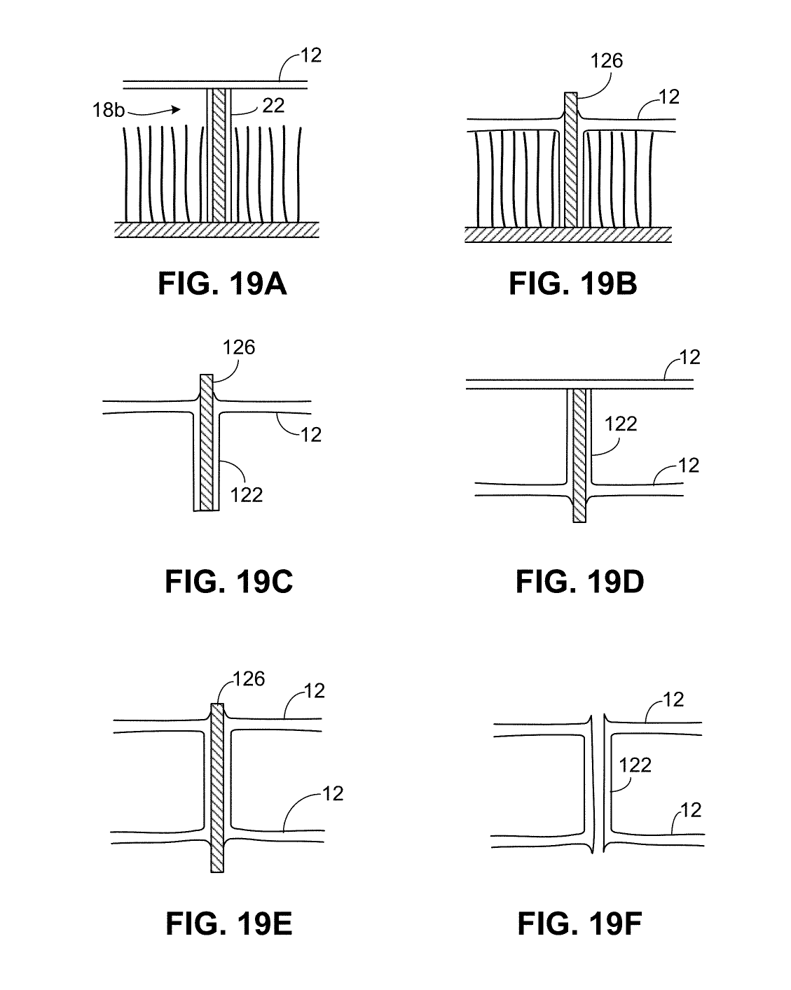

FIGS. 19A-F show a similar process for forming passages through spacer fabrics and the like. FIG. 19A schematically shows a short fiber segment 18b disposed vertically between bristles of a brush, with one end of the fiber segment elevated above the bristles. Fiber segment 18b has a solid non-resin core 126, such as of metal wire or the like, encased in a sheath 122 of resin. Many other fiber segments (not shown) are similarly disposed between the brush bristles, and the fiber segments are heated so as to soften their sheaths. A carrier sheet 12, such as a resin film, is supported on the exposed ends of the fiber segments and pressed down to the tops of the bristles, such as by rolling over the sheet with a compliant roller and light pressure. As the sheet is pressed downward, the non-resin cores pierce the sheet while the softened sheaths fuse to the resin of the sheet, as shown in FIG. 19B. The preform product is then removed from the brush (FIG. 19C) and inverted, with another sheet 12 supported on the other ends of the fiber segments (FIG. 19D). This second sheet 12 is then fused to the sheaths of the fiber segments as the core penetrates and is exposed on an opposite side of the sheet (FIG. 19E). This fusing of the second sheet can be as discussed above with respect to FIGS. 18A-D. Alternatively, the space surrounding the fiber segments between the sheets can be flooded with coolant and the second sheet then heated from its outer surface, causing the sheet to melt and flow only directly over the fiber segments where not in direct cooling contact with the coolant. Following fusing of the fiber sheath to both spaced sheets 12, the non-resin core 126 is removed, either by mechanical, magnetic or other means, and discarded—leaving an open passage 124 through the product.

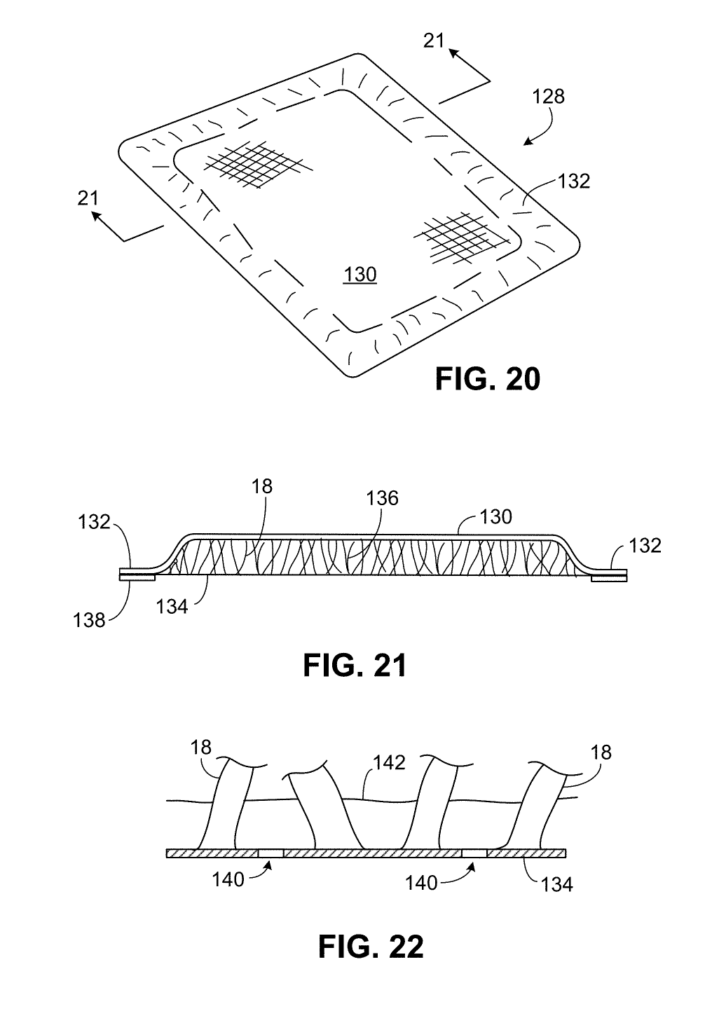

FIG. 20 shows a flexible patch 128, such as for wound treatment or transdermal drug delivery. The patch has an impermeable outer cover 130, such as of a laminate of a non-woven material over an inner film. Referring also to FIG. 21, the patch has sealed selvedges 132 surrounding an interior region in which the outer cover 130 is spaced from the inner liner 134 of the patch that faces the skin in use. The liner 134 is a permeable membrane or permeable non-woven material that permits some flow of at least air, or air and medicament, across the liner to and from an interior cavity 136 of the patch. Adhesive 138 directly below the selvedges of the patch adheres the patch to skin, with the outer cover supported across the interior region by small stems 18 connecting the outer cover and inner liner. Patch 128 may be formed by the methods described above, with the outer cover as one carrier sheet and the inner liner as the other. After formation, the spacer fabric is die cut to the desired patch shape and sealed about its edges to form the patch selvedges, crushing the stems in the selvedges, preferably under conditions that cause the stem resin to flow in the selvedges and seal the outer cover to the inner liner. Adhesive 138 is applied as a pressure-sensitive adhesive and covered with a peelable release liner (not shown). The space between the liner and outer cover allows some air flow to and from the wound site, and can promote wicking of moisture away from the skin.

Referring also to FIG. 22, in some cases inner liner 134 is a perforated film defining apertures through the liner, for exposing the underlying skin to a medicament 142 disposed within the patch between and surrounding the stems 18. The medicament can be in the form of a gel, for example, that disperses through the apertures over time for a controlled release of medicament.

Patch 128 may be fashioned of a length to completely wrap around and encase a human joint or limb, with an interior containing a material that remains sufficiently flexible to allow wrapping but that permanently stiffens when activated, turning the patch into a support brace or cast. Activation may be accomplished, for example, by hydration or by radiation cross-linking. The outer cover and inner liner contain the stiffening material and prevent contact with skin.

Patch 128 can also be fashioned for heat or cold therapy, with exothermic or endothermic materials encased within the interior of the patch between the stems and activated for treatment.

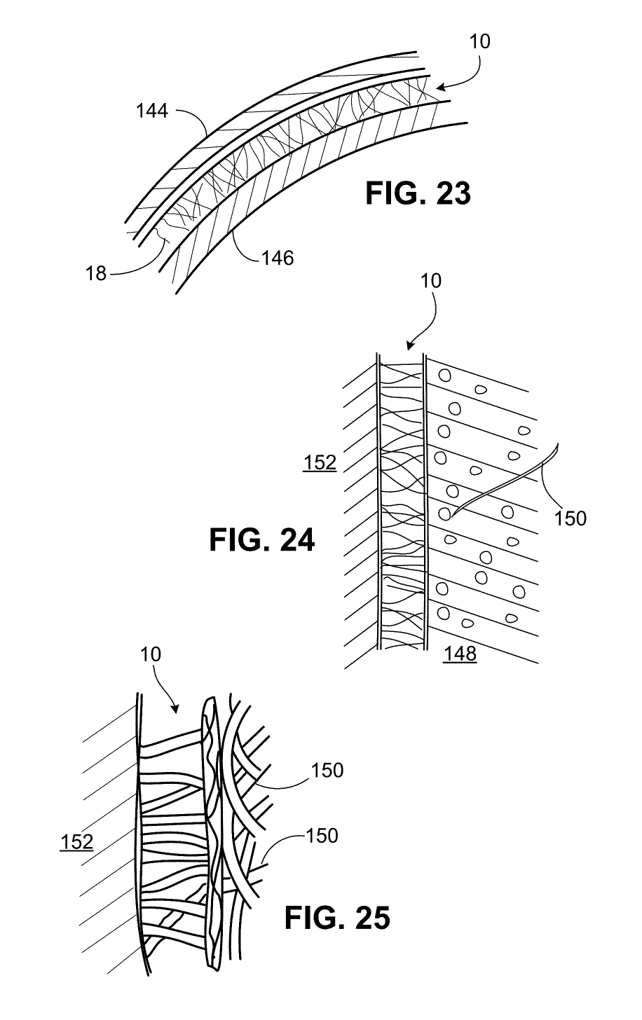

FIG. 23 illustrates the use of a spacer fabric, formed according to the methods described above, as an impact-absorbing layer. In this case, the spacer fabric 10 is placed between the hard shell 144 and the soft liner 146 of a bicycle helmet. The stems 18 crumple upon local pressure overload, dissipating energy. The spacer fabric thus provides a ‘crumple zone’. Because the spacer fabric can be fashioned to have different crush resistances while retaining overall permeability, it may also be configured to be suitable as a soft support fabric for burn victims. The carrier sheet materials may also be selected to enable thermoforming of the completed spacer fabric, such as for making impact-resistant egg cartons and other packaging.

FIGS. 24 and 25 shows the spacer fabric 10 functioning to distribute liquid, such as irrigating water. In FIG. 24, the spacer fabric lines a planter containing soil 148 in which plants are growing. Roots 150 from the plants are embedded in the soil and receive water wicking from within spacer fabric 10. The spacer fabric is shown here lining a vertical wall 152 of the planter, and may be filled with water from its upper edge. The carrier sheet forming the side of the spacer fabric in contact with the soil is water-permeable. Spacer sheet 10 allows irrigation water to travel quickly over long distances for even watering at all soil depths. FIG. 25 shows a similar arrangement but in a hydroponics environment, with the living plant roots 150 in direct contact with a permeable non-woven material forming the watering side of the spacer fabric.

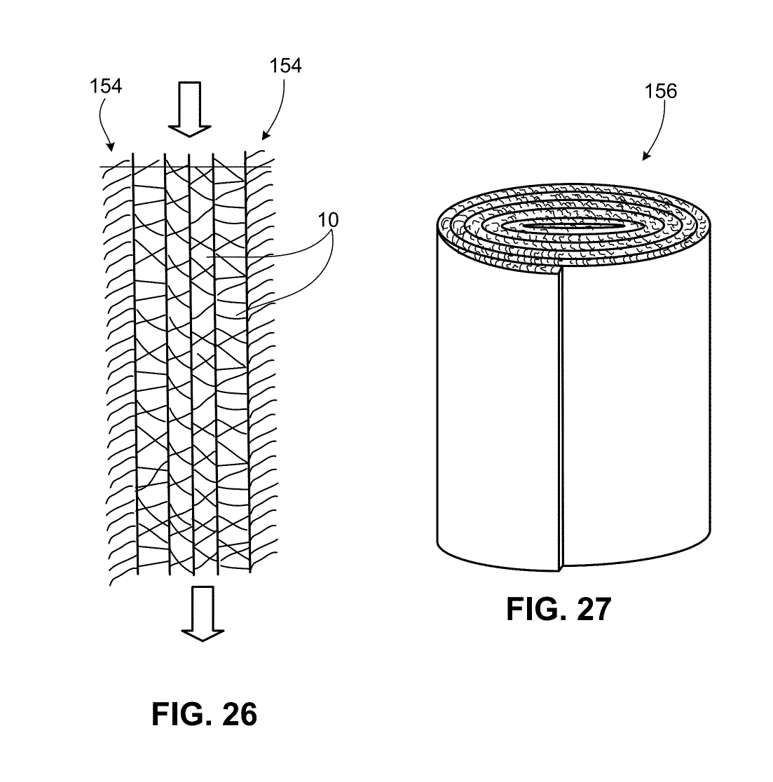

FIGS. 26 and 27 illustrate filtering applications of the spacer fabric. Because the spacer sheet can be fashioned with a desired overall density of stems 18 connecting the two carrier sheets, such as by varying the parameters of the needling process described above, the spacer fabric can be configured to provide a filtering function for fluids (liquid or gas) caused to flow along the space between the sheets, around the stems. To illustrate the concept, FIG. 26 shows four layers of spacer fabric 10 held between impermeable walls 154. The fluid to be filtered is caused to flow in the direction of the arrows, splitting into separate flows along each layer of spacer fabric. Particles from the flow of fluid become trapped between the stems of the spacer fabric layers, such that the exiting flow has been filtered. Because the spacer fabric can be made to be flexible, it can also be rolled to form a filter cartridge 156, as shown in FIG. 27. Cartridge 156 is essentially a coil of spacer fabric, with open ends. Cartridge 156 may be inserted into a suitable housing and fluid forced to flow from one end of the cartridge to the other, with the stems filtering particulates from the fluid.

In some cases, one or both of the carrier sheets of the spacer fabric are stretchable within their plane. For example, the carrier sheets may be an elastomeric film or may be a non-woven material containing stretchable fibers. In this manner, either one or both sides of the spacer fabric may be stretchable. This may have particular advantage in bandaging applications, for example.

The spacer fabric can be fashioned to have a particularly high volume-to-weight ratio and can be all formed of a single type of resin, providing for low material costs and weight, and enabling recyclability. It can be made flexible or stiff, for various applications. Either or both side surfaces of the spacer fabric may be impermeable or permeable, such as for the uses discussed above. The high proportion of air volume and the relatively thin walls of the stems means that the spacer fabric can be fashioned to have relatively high thermal insulation properties, and may even be used as an insulating layer in the building trades.

While a number of examples have been described for illustration purposes, the foregoing description is not intended to limit the scope of the invention, which is defined by the scope of the appended claims. There are and will be other examples and modifications within the scope of the following claims.

What is claimed is:

1. A spacer product comprising two spaced apart carrier sheets, each carrier sheet having a side surface facing the other carrier sheet; and
a multiplicity of non-tapered resin stems extending from and interconnecting the side surfaces of the carrier sheets;
wherein the stems extend at different angles from the carrier sheets; and
wherein the stems are secured to the side surfaces of the carrier sheets at weld points in which resin of the stems is solidified in a weld with resin of the side surface.

2. The spacer product of claim 1, wherein the side surfaces are formed by resin film.

3. The spacer product of claim 2, wherein the stems and the film of the side surfaces are of similar thickness.

4. The spacer product of claim 2, wherein the resin film forming the side surfaces also forms opposite surfaces of the carrier sheets.

5. The spacer product of claim 1, wherein the stems are in the form of hollow cylindrical tubes.

6. The spacer product of claim 5, wherein the stems have longitudinal seams extending along their length.

7. The spacer product of claim 5, wherein the hollow stems define passages through the spacer product, the passages open at outer surfaces of the carrier sheets.

8. The spacer product of claim 7, wherein the passages are sealed to a cavity defined between the carrier sheets.

9. The spacer product of claim 1, wherein the stems have a length-to-thickness ratio of between 10 and 60.

10. The spacer product of claim 1, wherein the stems have a nominal stem length of at least 1.5 mm and a nominal thickness of less than about 0.2 mm.

11. The spacer product of claim 1, wherein the stems are of different nominal thicknesses.

12. The spacer product of claim 1, wherein the stems are of longitudinally drawn resin.

13. The spacer product of claim 1, wherein the stems are of a pseudo-random distribution across the base.

14. The spacer product of claim 1, wherein the fibers comprise bicomponent fibers having a sheath of one resin overlaying a core of another resin.

15. The spacer product of claim 14, wherein the sheath resin is welded to resin of at least one of the carrier sheets.

16. The spacer product of claim 1, wherein at least one of the carrier sheets comprises a non-woven fabric, and wherein the stems are welded directly to resin of fibers of the non-woven fabric.

17. The spacer product of claim 1, wherein at least one of the carrier sheets is air-permeable throughout its thickness.

18. The spacer product of claim 1, further comprising unattached stems disposed between the carrier sheets, each unattached stem secured to only one of the carrier sheets.

19. The spacer product of claim 1, wherein the side surfaces bound a sealed internal cavity within the spacer product.

20. A method of making a spacer product, the method comprising:
orienting a number of extruded resin fibers in a common direction, with an end of each fiber exposed and positioned within a distance of a common datum, the distance being less than 20 percent of an average length of the fibers;
engaging the exposed ends of the fibers with a side of a first carrier sheet extending normal to the common direction;
permanently securing the engaged ends of the fibers to the first carrier sheet by welding resin of the fibers to resin of the first carrier sheet, forming a precursor sheet with the fibers having distal ends spaced from the first carrier sheet; and
securing the distal ends of the fibers to a surface of a second carrier sheet, such that the fibers hold the first and second carrier sheets in a spaced relation.
